(19) United States
(12) Patent Application Publication
(10) Pub. No.: US 2018/0063203 A1
(43) Pub. Date: Mar. 1, 2018

(54) PAIRING COMPUTER SYSTEMS WITH CONFERENCING SYSTEMS USING A VIDEO INTERFACE

(71) Applicant: Polycom, Inc., San Jose, CA (US)

(72) Inventors: Sandeep Marella, Hyderabad (IN); Chandrakiran Sarvepally, Hyderabad (IN)

(21) Appl. No.: 15/370,433

(22) Filed: Dec. 6, 2016

(30) Foreign Application Priority Data
Sep. 1, 2016 (IN) 201631029985

(51) Int. Cl. H04L 29/06

(52) U.S. Cl. CPC H04L 65/1069; H04W 88/08; H04L 65/403

(57) ABSTRACT

A conferencing system includes a computer system coupled to a base station via a first connection. The computer system receives display identification data associated with the base station via the first connection. The computer system uses the received information to determine connectivity information associated with the base station. Also, the computer system connects to the base station via a second connection using the determined connectivity information. The computer system and the base station communicate data (e.g., video data, etc.) using the first connection or the second connection. The first connection can be based on video interface technology. For example, High-Definition Multimedia Interface (HDMI) technology, DisplayPort technology, any other video interface technology with capabilities for information that is the same as or similar to enhanced extended display identification data (E-EDID information) or DisplayID information, etc.

### CROSS-REFERENCE TO RELATED APPLICATIONS

This application claims the benefit of Indian Provisional Application No. 201631029985, filed Sep. 1, 2016, the contents of which is included in its entirety by reference.

### FIELD

The inventive concepts relate generally to communication systems, and more particularly to pairing a base station with computer system using a video interface.

### BACKGROUND

Conferencing systems, such as audio conferencing systems, video conferencing systems, or multimedia conferencing systems, facilitate meetings between at least two participants that are remotely located to one another. Some conferencing systems include a base station at each participant's location to enable communication.

A base station can be an endpoint or a multipoint control unit (MCU). An endpoint is a terminal that contains hardware, software, or a combination thereof and is capable of providing real-time, two-way audio/visual/data communication with another endpoint or an MCU over a network. An MCU manages conferences between multiple endpoints. In some cases, an MCU may be embedded in an endpoint so that the device acts as both an endpoint and an MCU. A base station may communicate with other communication systems (e.g., one or more components of conferencing systems located at other sites, etc.) over conventional circuit or packet switched networks, such as the public switched telephone network (PSTN) or the Internet. A base station can also communicate with peripherals coupled to the base station. These peripherals include input/output (I/O) devices, such as a microphone, a display device, a speaker, a haptic output device, etc.

Some base stations are capable of receiving content (e.g., graphics, presentations, documents, still images, moving images, live video, etc.) from computer systems via video interfaces. In this way, a participant of a conference can couple a computer system to a base station via a video interface in order to present data stored on the computing device to other participants of the conference. Common video interfaces are the High-Definition Multimedia Interface (HDMI) and Video Graphics Array (VGA) interface. HDMI is a registered trademark of HDMI Licensing, LLC. Normally, coupling a computer system to a base station via HDMI is performed for passing content from the computer system to the base station. For this example, the base station merely presents the content via an output device (e.g., a display device, a speaker, etc.) coupled to the base station.

In at least one scenario, a computer system wirelessly controls a base station. Here, a conferencing system uses a computer system that is within a predetermined vicinity of the base station as a peripheral of a base station. The computer system includes hardware, software, or a combination thereof (e.g., a software application, dedicated circuitry, a combination of software and dedicated circuitry, etc.) that enables wireless control of the base station.

In some situations, establishing wireless control of the base station requires the computer system to first establish a conference with other remotely located computing devices capable of audio/video communication independent of a base station. In this initial arrangement, the computer system communicates audio and/or video with the other remotely located computing devices without using any base station. To use the base station, the computer system wirelessly pairs with the near-end base station after the conference with the other remotely located computing devices is established. Here, the computer system transfers the conference to the near-end base station after successful pairing. Following the transfer, the near-end base station takes over conferencing functions—for example, receiving far-end audio and/or video from the other remotely located computing devices, and sending the received audio and/or video to I/O devices (e.g., a display device, a speaker, etc.) associated with the near-end base station.

Wirelessly pairing the base station with the computer system may require the computer system to decode the base station's internet protocol (IP) address from an ultrasonic beacon that is output by the base station's loudspeaker and received by the computer system's microphone. Using the decoded IP address, the computer system establishes a wireless connection with the base station. Such a technique is described in U.S. Pat. No. 8,896,651 entitled “Portable Devices as Videoconferencing Peripherals,” which is hereby incorporated by reference in its entirety. Even though this technique allows for wireless control of the base station, many pieces must be provided (e.g., an ultrasonic system, a wireless system, etc.). Also, several user operations may be required (e.g., inputting pairing codes for authentication or authorization of devices before the control is established, etc.).

### SUMMARY

A conferencing system according to the present invention includes a computer system coupled to a base station via a first connection. The computer system receives display identification data associated with the base station through the first connection. The computer system uses the received information to determine connectivity information associated with the base station. Also, the computer system connects to the base station via a second connection using the determined connectivity information. The computer system and the base station communicate data (e.g., video data, etc.) using the first connection or the second connection. For some embodiments, the computer system controls the base station by communicating commands to the base station via the first connection or the second connection. The first connection can be based on video interface technology. For example, High-Definition Multimedia Interface (HDMI) technology (which includes enhanced extended display identification data (E-EDID information)), DisplayPort technology (which includes DisplayID information), any other video interface technology with capabilities for information that is the same as or similar to E-EDID or DisplayID information, etc. The display identification data that is communicated via the first connection includes E-EDID information, DisplayID information, or any other data structure with capabilities that are the same as or similar to E-EDID or DisplayID information. The second connection can include at least one network connection. DisplayPort technology is a digital interface developed, certified, and promoted by the Video Electronics Standards Association (VESA). DisplayPort and DisplayID are trademarks of VESA.

Other features or advantages attributable to the inventive concepts described herein will be apparent from the accompanying drawings and from the detailed description that follows below.

### BRIEF DESCRIPTION OF THE FIGURES

The accompanying drawings, which are incorporated in and constitute a part of this specification, illustrate an implementation of methods, apparatuses, and systems consistent with the inventive concepts set forth herein and, together with the detailed description, serve to explain advantages and principles consistent with the inventive concepts set forth herein. The accompanying drawings represent examples and not limitations in which like references indicate similar features. Also, some conventional details may be omitted in the drawings to avoid obscuring the inventive concepts set forth herein.

FIG. 1 illustrates a conferencing system according to one embodiment.

FIG. 2 schematically illustrates a computer system coupled to a conferencing system according to one embodiment.

FIG. 3 illustrates a configuration of an HDMI transmitting (Tx) unit and an HDMI receiving (Rx) unit according to one embodiment.

FIG. 4 illustrates, in flow-chart form, a process for pairing with and then controlling a base station using a computer system according to one embodiment.

FIG. 5 illustrates, in block diagram form, an exemplary graphical user interface for a computer system that controls a base station according to one embodiment.

### DETAILED DESCRIPTION OF THE PREFERRED EMBODIMENTS

One issue to consider when a computer system controls a base station is how to reduce the amount of user interaction required to achieve the control. Embodiments described herein provide a solution that assists with reducing or eliminating this issue. For example, at least one embodiment described herein enables a computer system to control a base station and to provide content to the base station. For this example, the control is performed using one or more network connections based on information provided via a video link and the content is provided via the video link or the network connection(s). For this example, the video link can be based on an HDMI technology that can communicate E-EDID information (e.g., an HDMI cable, etc.), a DisplayPort technology that can communicate DisplayID information (e.g., a DisplayPort cable. etc.), or any similar video interface technology with capabilities for information that is similar to or the same as E-EDID information or DisplayID information. For brevity, E-EDID information, DisplayID information, and any other type of information that is similar to or the same as E-EDID or DisplayID information is referred to throughout this document as “display identification data.” As shown in this example, the video link communicatively couples the computer system and the base station. This example can assist with providing an amount of user interaction that is less than the amount required to achieve control of the base station via an ultrasonic beacon. For another example, the control is performed over the video link and the content is provided via the video link or the network connection(s).

In the following description, for purposes of explanation, numerous specific details are set forth in order to provide a thorough understanding of the inventive concepts set forth herein. It will be apparent, however, to one skilled in the art that the inventive concepts set forth herein may be practiced without these specific details. In other instances, structure and devices are shown in block diagram form in order to avoid obscuring the inventive concepts set forth herein. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the inventive concepts set forth herein, and multiple references to “one embodiment” or “an embodiment” should not be understood as necessarily all referring to the same embodiment.

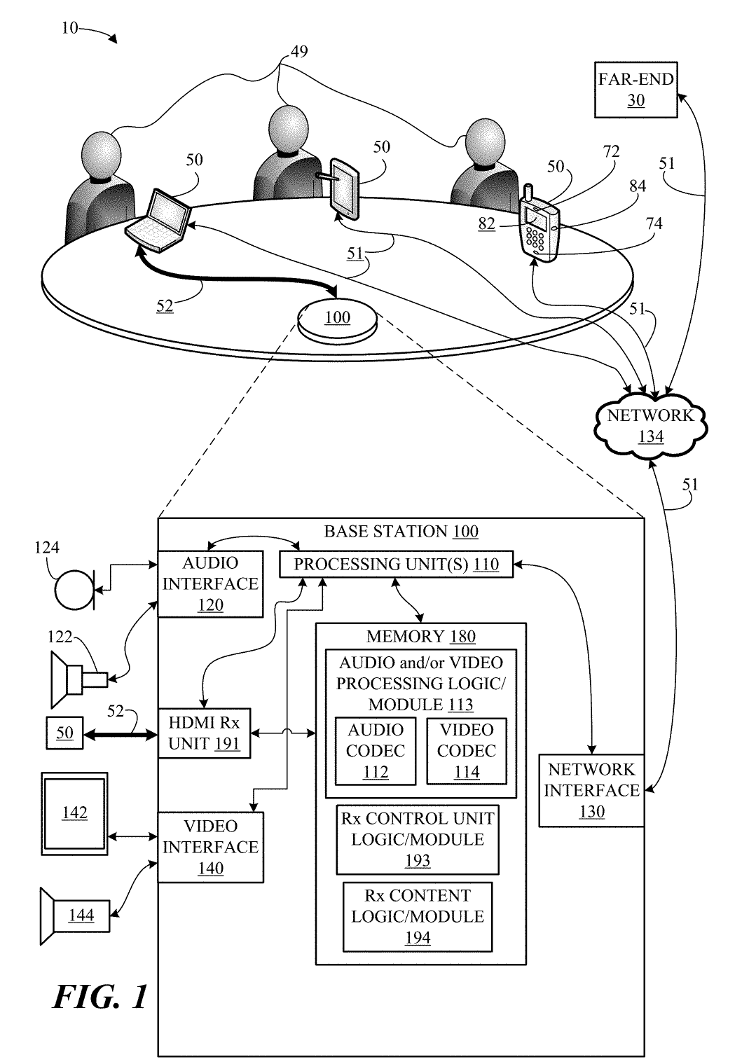

Referring to FIG. 1, a conferencing system 10 includes a near-end base station 100, one or more computer systems 50, a network 134, and a far-end 30. The system 10 can be used for any type of conferencing, including audio, video, and/or multimedia conferencing (e.g., a virtual meeting, etc.). Thus, the system 10 enables participants 49 to conduct a conference with other remotely located participants on the far-end 30 over the network 134. The far-end 30 is represented as a single entity, but it should be appreciated that the far-end 30 includes one or more remotely located base stations for facilitating the conference between the participants 49 and the other participants (not shown) that are remotely located away from the participants 49.

The near-end base station 100 can include an audio interface 120, a video interface 140, an HDMI receiving (Rx) unit 191, one or more processing units 110, memory 180, and a network interface 130. For one embodiment, the base station 100 includes (or is coupled to) a loudspeaker 122 and one or more microphones 124. The loudspeaker 122 and the microphone(s) 124 are coupled to the audio interface 120 for outputting and capturing audio, respectively. Additional acoustic devices may optionally be in the present system 10 (e.g., a microphone pod, ceiling microphones, other acoustic devices, etc.). For another embodiment, the base station 100 includes (or is coupled to) a display device 142 and a camera 144. The display device 142 and the camera 144 are coupled to the video interface 140 for outputting and capturing images, respectively. Images can be still images, video, etc. In some instances, the audio interface 120 and the video interface 140 are merged, such as the use of an HDMI output to a television acting as the video and audio output.

For one embodiment, the base station 100 includes an HDMI receiving (Rx) unit 191 and one or more processing units 110. Each of the HDMI Rx unit 191 and the processing unit(s) 110 is implemented as hardware, software, or a combination thereof. For one embodiment, the base station 100 (e.g., the HDMI Rx unit 191 and/or the processing unit(s) 110, etc.) includes electronic circuitry, such as (but not limited to) central processing unit (CPUs), graphics processing units (GPUs), digital signal processors (DSPs), other integrated circuits (ICs), and/or other electronic circuits that execute code to implement one or more operations associated with the HDMI Rx unit 191 and/or the processing unit(s) 110, as described herein. For one embodiment, the base station 100 includes memory 180 for storing such code. In this situation, execution of the stored code by the electronic circuitry in the base station 100 causes the circuitry to perform operations associated with the HDMI Rx unit 191 and/or the processing unit(s) 110 as described herein. For one embodiment, the memory 180 is a machine-readable medium that includes any mechanism for storing information in a form readable by a machine (e.g., the base station 100, etc.). A machine-readable medium, therefore, includes any non-transitory storage medium that can be read by a machine (e.g., the base station 100). Examples include, but are not limited to, read only memory (ROM), random access memory (RAM), magnetic disk storage media, optical storage media, and flash memory.

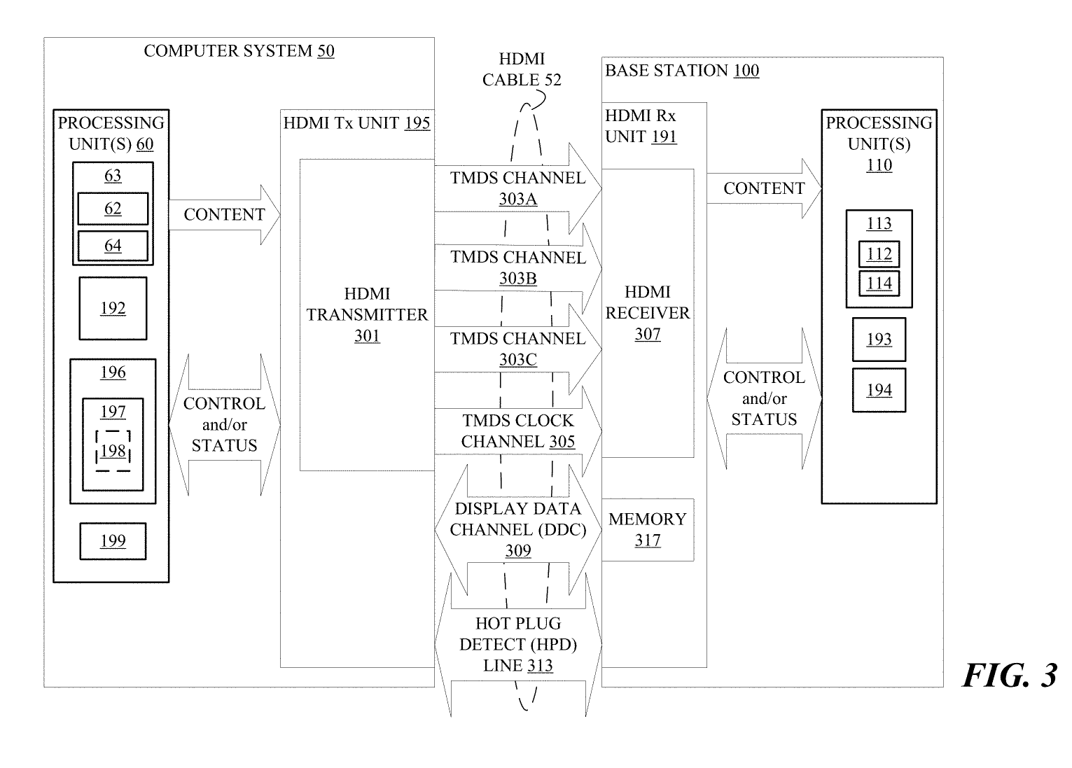

The HDMI Rx unit 191 enables a computer system 50 to provide content to the base station 100 and to receive information for controlling the base station 100. The control of the base station 100 can be performed using commands communicated either through a network connection or through a video link 52. For one embodiment, the video link 52 communicatively couples a computer system 50 with the base station 100. More details about the HDMI Rx unit 191 are described below in connection with FIGS. 3-5B.

The processing unit(s) 110 include an audio and/or video (AV) processing logic/module 113, an Rx control unit logic/module 193, and an Rx content logic/module 194. The AV processing logic/module 113 includes an audio codec 112 and a video codec 114. The codecs 112 and 114 can be coupled to the interfaces 120 and 140, respectively. The codecs 112 and 114 are for encoding and decoding audio and video, respectively. Sound captured by the microphone 124 and images (e.g., video, moving images, still images, etc.) captured by the camera 144 are respectively provided to the codecs 112 and 114 for encoding. The network interface 130 receives the encoded audio and video from the codecs 112 and 114 and communicates the encoded audio and video via the network 134 to the far-end 30. The network interface 130 also receives encoded audio and video from the far-end 30 via the network 134. The codecs 112 and 114 decode the received audio and video, which are output by the loudspeaker 122 and/or the display device 142. Data (e.g., video, audio, other data, etc.) that is processed by, received by, or transmitted from the base station 100 can be stored in the memory 180.

The Rx control unit logic/module 193 receives data from either the HDMI Rx unit 191 or the network interface 130 for control of the base station 100. For one embodiment, the Rx control unit logic/module 193 causes the base station 100 to perform operations in response to control commands received from the HDMI Rx unit 191. When these control commands are provided over a video link 52 that is based on an HDMI specification (e.g., the HDMI 1.3 specification, etc.), the control commands are preferably provided according to the Consumer Electronics Control (CEC) portion of the HDMI specification. When CEC commands are used, manufacturer specific commands are used for versions of the videoconferencing control functions, as they are not defined in the CEC standard. For an alternate embodiment, the control commands are provided over a network connection 51 that is established based on information provided over the video link 52, as described below. For this embodiment, the Rx control unit logic/module 193 receives the control commands from the network interface 130 and performs the necessary operations.

The Rx content logic/module 194 is used to receive local content from the computer systems 50 via the HDMI Rx unit 191 and/or the network interface 130. For one embodiment, the Rx content logic/module 194 is also used to receive far-end content from the far-end 30 via the network interface 130. Receiving content from the far-end 30 is conventional and not described in detail for brevity.

When the Rx content logic/module 194 is used to receive local content from the computer system 50 via the HDMI Rx unit 191, the local content is un-encoded content that is communicated through the video link 52. When the Rx content logic/module 194 is used to receive local content from the computer systems 50 via the network interface 130, the local content is encoded and communicated through the network 134 and the network connection 51 in a packetized form. The Rx content logic/module 194 provides the encoded local content to the audio and/or video processing logic/module 113, where the encoded local content is decoded and output using the display 142. For one embodiment, the audio and/or video processing logic/module 113 combines the decoded local content with the un-encoded local content as a complete video output that is output using the display 142. If desired, the local content that is received via the video link 52 or the network connection 51 is mixed with video from the far-end 30 and/or video from the near-end computer systems 50. This mixture of local content and video is processed for presentation to participants via the loudspeaker 122 and/or the display 142. Additionally or alternatively, this mixture of local content and video is processed for transmission to computer systems 50, which output the mixture via their respective loudspeakers and/or the displays (e.g., loudspeaker 72, display 82, etc.).

For one embodiment, the audio and/or video processing logic/module 113 encodes local content that is received from the computer systems 50 via the HDMI Rx unit 191 and/or the network interface 130 for transmission to the far-end 30 via the network interface 130. As explained above, local content is received in at least one of the following manners—(i) through the HDMI Rx unit 191; or (ii) through the network interface 130. If local content is received over the video link 52 and captured by the HDMI Rx unit 191, the captured content is properly packetized and provided to the network interface 130 for transmission to the far-end 30. If local content is received over the network interface 130 (based, for example, on capturing and transmission done by a program on the computer system 50), the content is properly packetized and provided to the network interface 130 for transmission to the far-end 30.

During a conference, many of the participants 49 likely have their own system 50. The computer system 50 can be a portable device, including, but not limited to, peripheral devices, cellular telephones, smartphones, tablet PCs, touch screen PCs, PDAs, hand-held computers, netbook computers, and laptop computers. The base station 100 can use the computer systems 50 as conferencing peripherals. Some of the computer systems 50 can have processing capabilities and functionality for operating a camera, a display, and a microphone and for connecting to the network 134. The network 134 can be a Wi-Fi network, Internet, and the like.

In general, the network interface 130 connects the base station 100, the computer system(s) 50, and the far-end 30 via network connections 51. Each connection 51 can include an Ethernet connection, a wireless connection, an Internet connection a cellular connection, any other suitable connection for conferencing, or a combination thereof. As part of the network interface 130 or separate therefrom, the base station 100 includes a peripheral interface (not shown) that enables the base station to communicate with local peripherals, such as the computer system(s) 50. Accordingly, the participants 49 connect their systems 50 with the network 134 so transport between the base station, the system(s) 50, and the far-end 30 uses the network 134. For one example, the network interface 130 connects the base station with the system(s) 50 using a local intranet of a local area network (LAN) that is part of the network 134. For this example, the LAN connects to a wide area network (WAN), such as the Internet to communicate with the far-end 30. The LAN may have a wireless local area network (WLAN), Wireless Fidelity (Wi-Fi) network, or similar type of wireless network for connecting the base station 100 with the computer system(s) 50 through a wired portion of the LAN. Alternatively, the base station 100 forms a personal area network (PAN) with the system(s) 50 using, for example, a Bluetooth interface. Other examples of a PAN interface include, but are not limited to, an infrared communication interface, a wireless universal serial bus (W-USB) interfaces, and a ZigBee interface.

In many instances, the computer system(s) 50 has high quality microphones 74, and the base station 100 uses the device's microphones 74 as conferencing microphones. In this way, several of the participants 49 use the microphones 74 on their system(s) 50 as conferencing microphones, and the close proximity of each microphone 74 to each participant 49 will likely offer high quality audio pickup for the conference. If the system(s) 50 have high quality cameras 84, the base station 100 uses the system(s)′ cameras 84 as conferencing cameras in close proximity to the participants 49.

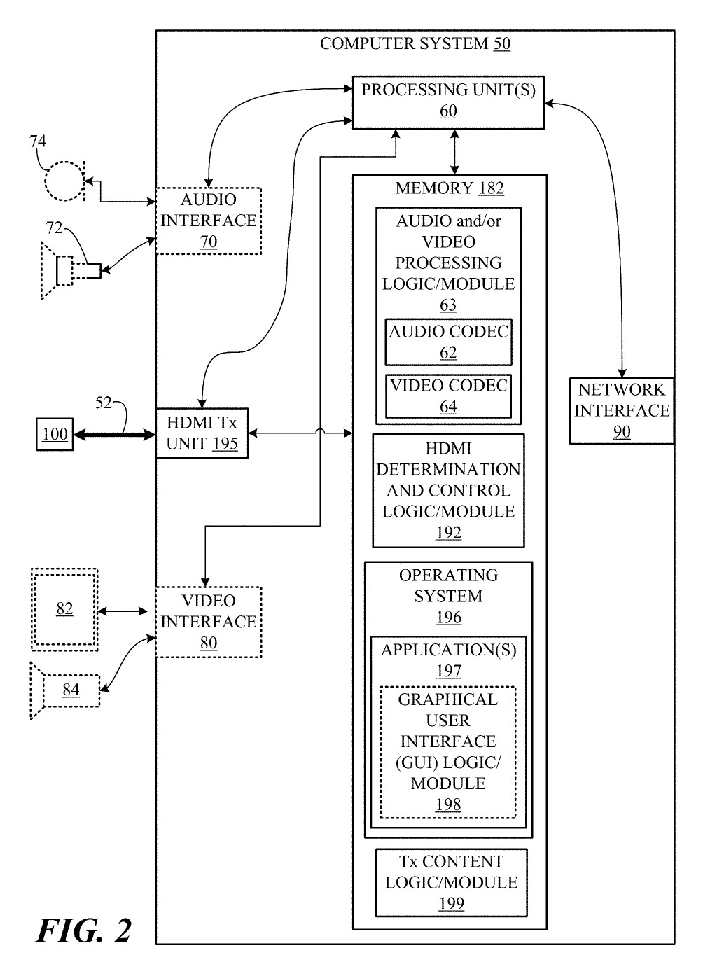

FIG. 2 illustrates a computer system 50 coupled to the base station 100 via the video link 52. For one embodiment, the computer system 50 includes an audio interface 70, a video interface 80, a HDMI Tx unit 195, one or more processing units 60, and a network interface 90. The audio interface 70 is similar to or the same as the display 120 described above in connection with FIG. 1, so it is not described in detail. The video interface 80 is similar to or the same as the display 140 described above in connection with FIG. 1, so it is not described in detail. The network interface 90 is similar to or the same as the network interface 130 described above in connection with FIG. 1, so it is not described in detail.

Each of the HDMI Tx unit 195 and the processing unit(s) 60 can be implemented as a combination of hardware and software. For one embodiment, the computer system 50 (e.g., HDMI Tx unit 195 and/or the processing unit(s) 60, etc.) includes electronic circuitry, such as (but not limited to) CPUs, GPUs, DSPs, other integrated circuits (ICs), and/or other electronic circuits that execute code to implement one or more operations associated the HDMI Tx unit 195 and/or the processing unit(s) 60 as described herein. For one embodiment, the computer system 50 includes memory 182 for storing such code. In this situation, execution of the stored code by the electronic circuitry in the computer system 50 causes the circuitry to perform the operations associated with the HDMI Tx unit 195 and/or the processing unit(s) 60 as described herein. For one embodiment, the memory 180 is a machine-readable medium that includes any mechanism for storing information in a form readable by a machine (e.g., the computer system 50, etc.). A machine-readable medium, therefore, includes any non-transitory storage medium that can be read by a computer (e.g., the base station 100). Examples include, but are not limited to, read only memory (ROM), random access memory (RAM), magnetic disk storage media, optical storage media, and flash memory.

Code stored in the memory 182 and executed by the processing unit(s) 60 and/or the HDMI Tx unit 195 causes the processing unit(s) 60 and/or the HDMI Tx unit 195 to implement at least one of the following: (i) the operating system (OS) 196; (ii) one or more applications 197; or (iii) one or more of the logic/modules 62, 63, 64, 192, 198, and 199. Each of the OS 196, application(s) 197, and logic/modules 62, 63, 64, 192, 198, and 199 is described below.

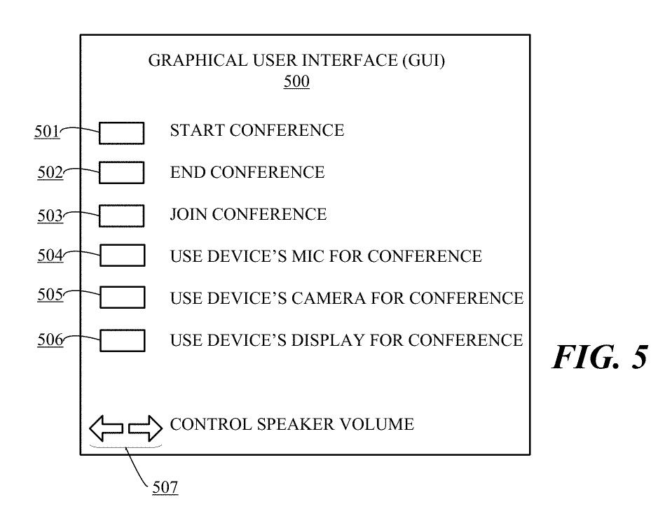

Each of the microphone 74, the speaker 72, the audio interface 70, the display 82, the camera 84, the video interface 80, and the graphical user interface (GUI) logic/module 198 is illustrated with a dashed box to show that it is an optional component of the system 50. Nevertheless, each of these components is not always an optional component of the system 50. Some embodiments may require one or more of these components—for example, a GUI logic/module is part of a computer system 10 as described below in connection with at least FIG. 5, a microphone 74 is part of a computer system 10, etc.

The microphone 74 is similar to or the same as the microphone 124 described above in connection with FIG. 1, so it is not described in detail. The speaker 72 is similar to or the same as the speaker 122 described above in connection with FIG. 1, so it is not described in detail. The display 82 is similar to or the same as the display 142 described above in connection with FIG. 1, so it is not described in detail. The camera 84 is similar to or the same as the display 144 described above in connection with FIG. 1, so it is not described in detail.

The computer system 50 includes an AV processing logic/module 63 that includes an audio codec 62 and a video codec 64. The codecs 62 and 64 are for encoding and decoding audio and video, respectively. The codecs 62 and 64 are similar to or the same as the codecs 112 and 114, respectively, so they are not described in detail. Data (e.g., audio, video, other data, etc.) that is processed by, received by, or transmitted from the computer system 50 is stored in the memory 182. This data includes, but is not limited to, at least one of the following: (i) images or video provided through the camera 84; (ii) content provided through the HDMI Tx unit 195; (iii) content provided through the network interface 90; or (iv) content associated with one or more applications 197 that are implemented by the circuitry of the system 50 (e.g., a word processor, conferencing application, etc.). This data also includes audio and/or any other data.

The computer system 50 includes an OS 196 for managing hardware and/or software of the computer system 50 and providing common services for one or more applications 197. The computer system 50 also includes an HDMI determination and control logic/module 192, which receives data from the HDMI Tx unit 195 and/or the network interface 90 for control of the base station 100. For one embodiment, the HDMI determination and control logic/module 192 processes data that is received from the HDMI Tx unit 195 to determine that the base station 100 can perform operations in response to commands transmitted from the HDMI Tx unit 195 and/or the network interface 90. For one embodiment, these commands are generated by the logic/module 192.

The logic/module 192 enables the OS 197 to detect a display associated with the base station 100 (e.g., the display 142 described above in connection with FIG. 1, etc.). For a specific embodiment, the OS 197 detects the display associated with the base station 100 in response to the logic/module 192 determining that the base station 100 is coupled to the HDMI Tx unit 195 via the video link 52. The logic/module 192 also enables the OS 197 to activate one or more applications 197 for audio/video conferencing. The application(s) 197 include, but are not limited to, computer programs, drivers, routines, and utilities. For example, the logic/module 199 enables the OS 197 to activate a virtual meeting room (VMR) application, which allows a user of the computer system 50 to control the base station 100 to establish a new conference or join an established conference. For a further example, the OS 197 automatically activates the VMR application in response to the logic/module 192 determining that the base station 100 is coupled to the HDMI Tx unit 195 via the video link 52. When one or more of the application(s) 197 includes a graphical user interface (GUI) logic/module 198, the OS 197 is enabled to generate a GUI that enables reception of user input by the computer system 50. The user input can be used for controlling the base station 100, as described in more detail in connection with FIGS. 3-5.

Audio and/or video can be communicated to or from the computer system 50 through the network interface 90 and/or the HDMI Tx unit 195. The Tx content logic/module 199 enables audio and/or video that is stored in the memory 182 or received from the microphone 74 and/or the camera 84 to be communicated between the HDMI Tx unit 195 and the base station 100. Audio and/or video communicated between the HDMI Tx unit 195 and the base station 100 is un-encoded and can be stored in the memory 182. For one embodiment, the HDMI Tx unit 195 enables the computer system 50 to control the base station 100 using information communicated through the video link 52. Control can be over the video link 52 (e.g., using the CEC protocol, etc.) or over a network connection (e.g., control commands sent using the network connection 51 described above in connection with FIG. 1). More details about the HDMI Tx unit 195 are described below in connection with FIGS. 3-5.

As one skilled in the art will appreciate, any type of connection can be used for communications between the system(s) 50 and the base station 100. For example, and as shown in FIG. 1, the computer system 50 can also be wirelessly coupled to other near-end computer systems 50, the far-end 30, and/or the base station 100 via the network 134.

With regard to wireless connections, the computer system 50 has a network interface 90 connected to the codecs 62 and 64, which is for wirelessly communicating audio and video between the near-end base station and far-end 30. For one example, the network interface 90 can connect to a typical cellular network 92 if the computer system 50 can be used for cellular communications. For another example, the network interface 90 can connect to the network 134 shown in FIG. 1 so the computer system 50 can communicate with other near-end computer systems 50, the far-end 30, and/or the base station 100 via the network 134. As will be appreciated, establishing a wired or wireless connection between the computer system(s) 50, the far-end 30, and/or the base station 100 via the network 134 requires particular protocols, applications, accounts, and other details that are pre-arranged for the connection to be possible so the details are omitted here.

FIG. 3 illustrates a configuration of an HDMI Tx unit 195 and an HDMI Rx unit 191 according to one embodiment. The HDMI Tx unit 195 can be found in the computer system(s) 50 described above in connection with FIGS. 1-2. The HDMI Rx unit 191 can be found in the base station 100 described above in connection with FIGS. 1-2.

For one embodiment, the HDMI Tx unit 195 and the processing unit(s) 60 convert the computer system 50 into an HDMI source device. The HDMI Rx unit 191 and the processing unit(s) 110 convert the base station 100 into an HDMI sink device. Thus, the base station 100 receives content from the computer system 50 and then outputs the received content. For a further embodiment, the base station 100 receives data (e.g., command signals, control signals, status signals, etc.) from the computer system 50 and then performs one or more operations in response to the received data.

The HDMI Tx unit 195 transmits a signal corresponding to content to the HDMI Rx unit 191 through multiple channels, which are then received by the HDMI Rx unit 191. A transmission channel includes: (i) three transition minimized differential signaling (TMDS) channels 303A-C, which are transmission channels for transmitting video and/or audio data; (ii) a TMDS clock channel 305, which is a transmission channel for transmitting the pixel clock; (iii) a display data channel (DDC) 309; and (iv) a hot plug detect (HPD) line 313.

The HDMI Tx unit 195 includes a transmitter 301 that converts, for example, the content (e.g., pixel data of the non-compressed image, etc.) into a corresponding differential signal, and transmits the converted signal to the HDMI Rx unit 191 connected via the video link 52 through the TMDS channels 303A-C. The transmitter 301 also drives a TMDS clock channel 305 with the a clock signal associated with the video and/or audio data transmitted via the three TMDS channels 303A-C. The HDMI Rx unit 191 includes a receiver 307 that receives the data transmitted via the three TMDS channels 303A-C and the TMDS clock channel 305.

The HDMI Tx unit 195 uses the DDC 309 for reading display identification data, such as, enhanced extended display identification data (E-EDID information) from the HDMI Rx unit 191. The display identification data represents identification and capability information of the base station 100. As shown, the HDMI Rx unit 191 includes memory 317 for storing the display identification data. The memory 317 includes a random access memory (RAM) and/or a read only memory (ROM). For one embodiment, the display identification data includes a unique identifier associated with the base station 100. Consequently, other base stations in the far-end 30 are identified by their own individual identifiers. Based on the display identification data, the HDMI transmitter 301 recognizes capabilities of the base station 100.

For one embodiment, the HDMI Tx unit 195 provides the display identification data to the HDMI determination and control logic/module 192 (which is illustrated in FIG. 2). Here, the logic/module 192 identifies the base station 100 and obtains connectivity information associated with the base station 100 from the display identification data (e.g., an internet protocol (IP) address, a pairing code for a PAN, etc.). In this way, the logic/module 192 enables pairing of the base station 100 with the computer system 50 without requiring the system 50 to decode the base station's IP address from an ultrasonic beacon that is output by the base station's loudspeaker and received by the computer system's microphone. Because the display identification data is provided at a relatively high speed, compared to the relatively lower rate of the ultrasonic transmission, pairing time is improved. Further, because the connectivity information is provided over a physical link, it is possible to simplify pairing of the base station 100 and the computer system 50 by eliminating the need to use one or more systems associated with using an ultrasonic beacon (e.g., a wireless system, an ultrasonic system, etc.). In this way, the overall cost of controlling the base station 100 with the conference control system 50 is reduced.

The computer system 50 uses a hot plug detect (HPD) line 313 to discover an existence of a connection to the base station 100. For example, the HDMI Tx unit 195 detects the connection via the HPD line 313 and provides status signals indicative of the connection's status to the logic/module 192. In response to receiving the status signals, the logic/module 192 provides one or more control signals to the HDMI Tx unit 195 that cause the unit 195 to obtain the display identification data from the memory 317 via the DDC 309.

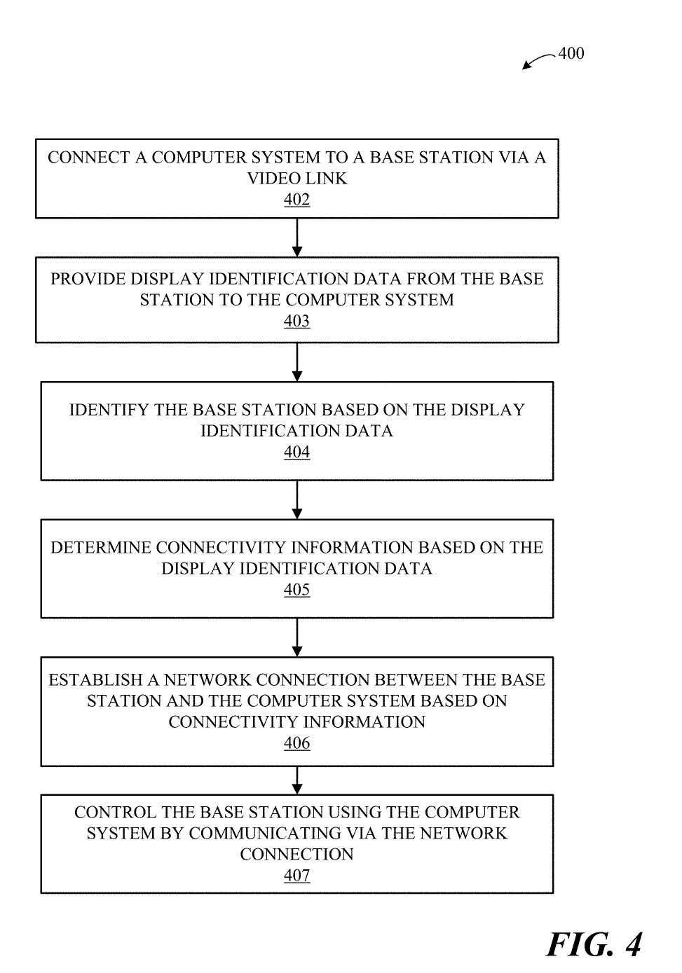

FIG. 4 is a flowchart of a process 400 for pairing with and then controlling a base station using a computer system according to one embodiment. Operation 400 applies to the computer system 50 and the base station 100 described above in connection with at least FIGS. 1-3. Operation 400 begins, in one embodiment, at block 402 by connecting a computer system 50 to a base station 100 via a video link 52. Here, the HPD line 313 is used by the computer system 50 to detect the HDMI connection to the base station 100. At block 403, the base station 100 provides its display identification data to the computer system 50. Next, at block 404, the computer system 50 processes or parses the display identification data to identify the base station 100. The display identification data includes one or more unique identifiers for identifying the base station 100 to the computer system 50. The unique identifier(s) can, for example, be included in bytes 8, 9, 10, 11, 12, 13, 14, and 15 of the basic E-EDID information structure that is defined by the HDMI specification. A first unique identifier representing the manufacturer of the base station 100 is assigned to bytes 8 and 9 of the basic E-EDID information structure. A second unique identifier representing the model number or product code of the base station 100 is assigned to bytes 10 and 11 of the basic E-EDID information structure. A third unique identifier representing the serial number of the base station 100 is assigned to bytes 12, 13, 14, and 15 of the basic E-EDID information structure.

For yet another embodiment, additional unique identifier(s) (e.g., fourth or higher unique identifiers, etc.) are included in the CEA-861 extension block associated with the E-EDID information structure. CEA stands for Consumer Electronics Association and is a registered trademark of the Consumer Technology Association. Specifically, the HDMI vendor specific data block (VSDB) of the CEA-861 extension block, which is part of the E-EDID specification, includes the additional unique identifier(s) of the base station 100. For one example, an additional unique identifier is the internet protocol (IP) address of the base station 100, which is found in the one or more bytes following the 24-bit identifier in the HDMI VSDB. The 24-bit identifier is the vendor's IEEE 24-bit registration number (least significant bit first). IEEE stands for Institute of Electrical and Electronics Engineers and is a registered trademark of Institute of Electrical and Electronics Engineers, Inc. The additional unique identifier(s) can represent more than just the internet protocol (IP) address of the base station 100. Information that can be represented by the unique identifier(s) includes, but is not limited to, the base station 50's capabilities and connectivity information associated with the base station 50. Each additional unique identifier is at least one bit. For example, the at least one bit includes one or more reserved bits in one or more of the VSDB bytes. For a more specific example, an additional unique identifier is a unique 32-bit identifier assigned to four VSDB bytes (e.g., bytes 13, 14, 15, and 16 of the VSDB, etc.).

The video link 52 between the computer system 50 and the base station 100 can be based on another audio/video interface technology that is similar to the HDMI technology. For example, the video link 52 is a DisplayPort cable based on a DisplayPort specification. For this example, at block 403, the base station 100 provides its display identification data as DisplayID information to the computer system 50. DisplayID information was designed to encompass any information in the basic E-EDID information structure, the CEA-861 extension block, and other extension blocks described in the HDMI specification. Consequently, and for this example, the base station 100's DisplayID information is similar to or the same as the E-EDID information described above—that is, the unique identifier(s) and the additional unique identifier(s).

At block 405, the computer system processes the display identification data to determine connectivity information associated with base station. For one embodiment, the connectivity information is included in the CEA-861 extension block or its equivalent (e.g., DisplayID, etc.). For example, the connectivity information is included in one or more additional unique identifiers, which is included in the CEA-861 extension block or its equivalent (e.g., DisplayID, etc.). This connectivity information enables the computer system 50 to connect to a network (e.g., the network 134 in FIG. 1) that the base station 100 is also coupled to. Connectivity information includes, but is not limited, a reachable internet protocol (IP) network address associated with the base station 100, a service set identifier (SSID) associated with the base station 100 (if the base station 100 is acting as an access point), a uniform resource locator (URL) associated with the base station 100, and one or more pairing codes associated with the base station 100. These one or more pairing codes are for short-range radio or wireless communications, such as Bluetooth, Near-field communication (NFC), etc. For one embodiment, each of the base station 100's IP network address, SSID, URL, and pairing code(s) is represented as a value. For this embodiment, the value is represented using one or more additional unique identifiers (as described above). Each of the values is at least one bit that is assigned to one or more reserved bits in the CEA-861 extension block or its equivalent (e.g., DisplayID, etc.). For example, each value is at least one bit that is assigned to one or more of the VSDB bytes of the CEA-861 extension block. For another example, a unique 32-bit identifier assigned to four VSDB bytes (e.g., bytes 13-16 of the HDMI VSDB, etc.) includes at least one of the base station's IP network address, SSID, URL, or pairing code(s). For one embodiment, the type of connectivity information is determined using at least one of the following: (i) reference to bits in the CEA-861 extension block or its equivalent (e.g., DisplayID, etc.); or (ii) reference to the manufacturer, model number, and/or serial number, if necessary, of the base station 100 (which are determined and described above in connection with block 404).

Operation 400 moves to block 406. Here, a network connection 51 between the base station 100 and the computer system 50 is established using the determined connectivity information. For one embodiment, the computer system 50 automatically connects to a network 134 that the base station 100 is coupled to using the connectivity information without the need for user input such as pairing codes or authenticating information. In this way, the connectivity information in the display identification data may assist with reducing or eliminating the need for some user interaction (e.g., inputting pairing codes, etc.) required to authenticate or authorize the pairing of the base station 100 with the computer system 50 in situations where an ultrasonic beacon is used. Establishing the network connection 51 between the base station 100 and the computer system 50 may also be performed in accord with the description provided above in connection with at least FIG. 1.

At block 407, the computer system 50 and the base station 100 communicate signals between each other via the network connection 51. The unique identifiers described above also include, for one embodiment, information for determining control options and commands available to the base station 100. The manufacturer, model number, serial number, and/or any of the additional unique identifiers in the display identification data (e.g., in bits of the VSDB bytes, etc.) are processed by the computer system 50 to determine commands that the base station 100 will respond to. As such, one or more drivers of the base station 100 and/or the computer system 50 may be loaded to effectuate the control via the network connection 51 in response to establishment of the network connection 51. In this way, the computer system 50 controls the base station 100. For one embodiment, the computer system 50 transmits a command signal via the network connection 51 to the base station 100. For this embodiment, the command signal causes processing unit(s) in the base station 100 to perform the command. Examples of the command include starting a conference, ending a conference, joining a conference, using the system 50's microphone 74 and/or camera 84 for the conference, adjusting a loudspeaker's volume, changing a display option, and performing additional functions. Some of these additional functions are similar to the typical functions available on a conventional remote control of a base station, such as controlling loudspeaker volume, moving cameras, changing display options, etc. For one embodiment, an application for audio/video conferencing (e.g., the application(s) 197 in FIG. 2, etc.) is activated in response to the established network connection 51. The activated application 197 can enable control of the base station 100 using one or more commands issued by the computer system 50, as described above. The computer system 50 provides the command to the base station 100 in response to user input received by the computer system 100 via a GUI in the activated application 197, as described below.

FIG. 5 illustrates, in block diagram form, an exemplary graphical user interface (GUI) 500 for a computer system 50 according to one embodiment. The GUI 500 enables the computer system 50 to control the base station 100's functions. For one embodiment, the GUI logic/module 198 (in FIG. 2) generates a GUI 500 for a conferencing application (e.g., the application(s) 197 in FIG. 2, etc.). When operated, a conferencing application that includes the GUI generated by the GUI logic/module 198 allows a participant 49 using the computer system 50 to control the base station 100.

The GUI 500 has a number of GUI objects 501-508, which represent operations that the conference control device 50 can direct the base station 100 to perform. These GUI objects 501-508 can be individually configured by the user, although some of them may operate automatically by default. The GUI objects 501-508 can include, but are not limited to, starting a conference, ending a conference, joining a conference, using the computer system 50's microphone 74 and/or camera 84 for the conference, and performing additional functions. Some of these additional functions can be similar to the typical functions available on a conventional remote control of a base station 100, such as controlling loudspeaker volume, moving cameras, changing display options, etc.

Some general discussion of the user interface items follows. By selecting the GUI object 501 to start a videoconference, for example, the computer system 50 can be used to initiate a videoconference. By selecting the GUI object 503 to join a current conference, the computer system 50 can become a peripheral device to a base station 100 managing a conference and take over its control. By selecting any of the GUI objects 504-506 to use the device's microphone, camera, or display, the user 49 can configure how the computer system 50 is to be used with the base station 100. Control of the base station 100 by the computer system 50 is described above in connection with at least FIG. 1, 2, 3, or 4.

For the embodiments of the invention described above in connection with FIGS. 1-5, an HDMI interface enables display identification data associated with a base station to be provided to a computer system. The display identification data can enable an improved technique for pairing the computer system with the base station. Specifically, the computer system identifies the base station and obtains connectivity information associated with the base station using the display identification data. In this way, pairing of the base station with the computer system can be performed without requiring the system to decode the base station's IP address from an ultrasonic beacon that is output by the base station's loudspeaker and received by the computer system's microphone. The connectivity information in the display identification data may also assist with reducing or eliminating the need for some user interaction required to authenticate or authorize the pairing of the base station with the computer system. Consequently, the computer system can establish a connection with the base station without the use of an ultrasonic beacon, which may assist with reducing the overall cost of controlling the base station 100 with the computer system 50. For at least the reasons set forth in this paragraph, embodiments of the invention assist with reducing or eliminating at least some of the unwanted issues associated with control of a base station by a computer system.

The embodiments described above were presented in view of HDMI technology. Nevertheless, it is to be appreciated that the embodiments described above can be implemented using other audio/video interface technologies capable of providing information that is similar to or the same as E-EDID information (e.g., DisplayPort technology that includes DisplayID information, etc.). When these other technologies are used, all necessary details such as required ports, transmission interfaces, receiving interfaces, protocols, and/or any other hardware, software, or combination of hardware and software are in accord with their respective specifications.

The above description is intended to be illustrative, and not restrictive. For example, the above-described embodiments may be used in combination with each other. Many other embodiments will be apparent to those of skill in the art upon reviewing the above description. The scope of the inventive concepts set forth herein should, therefore, be determined with reference to the appended claims, along with the full scope of equivalents to which such claims are entitled. In the claims, the terms “including” and “in which” are used as the plain-English equivalents of the respective terms “comprising” and “wherein.” Also, the use of “at least of A, B, or C” includes: (i) A only; (ii) B only; (iii) C only; (iv) A and B; (v) A and C; (vi) B and C; and (vii) A, B, and C.

In the description above and the claims below, the term “connected” can refer to a physical connection or a logical connection. A physical connection indicates that at least two devices or systems co-operate, communicate, or interact with each other, and are in direct physical or electrical contact with each other. For example, two devices are physically connected via an electrical cable. A logical connection indicates that at least two devices or systems co-operate, communicate, or interact with each other, but may or may not be in direct physical or electrical contact with each other. Throughout the description and claims, the term “coupled” may be used to show a logical connection that is not necessarily a physical connection. “Co-operation,” “communication,” “interaction” and their variations includes at least one of: (i) transmitting of information to a device or system; or (ii) receiving of information by a device or system.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

1. A method, comprising:
receiving, over a first connection and by a computer system, display identification data associated with a base station when the computer system is connected to the base station via the first connection;
determining connectivity information of the base station from the received display identification data; and
connecting the computer system to the base station via a second connection using the determined connectivity information.

2. The method of claim 1, wherein the first connection is a wired video connection, and wherein the second connection is a network connection.

3. The method of claim 2, wherein the wired video connection conforms to a High Definition Multimedia interface (HDMI) specification or a DisplayPort specification.

4. The method of claim 2, wherein the network connection comprises at least one of an Ethernet connection, a Wide Area Network (WAN) connection, an Internet connection, a cellular connection, a Local Area Network (LAN) connection, an intranet connection, or a Wireless Local Area Network (WLAN) connection.

5. The method of claim 2, further comprising:
communicating content by the computing system to the base station, wherein the communication is performed using the first connection or the second connection.

6. The method of claim 2, further comprising identifying the base station based on the display identification data.

7. The method of claim 2, further comprising providing, by the computer system, a control signal to the base station via the second connection.

8. The method of claim 7, wherein the control signal is provided to the base station in response to a user input received by the computer system.

9. The method of claim 7, wherein the provided control signal is one of: start a conference, end a conference, join a conference, control loudspeaker volume, or change a display option.

10. A computer system, comprising:
a video output configured to:
receive, over a first connection, display identification data associated with a base station when the video output is connected to the base station via the first connection;
a network interface; and
a processing unit coupled to the video output and the network interface, the processing unit being configured to:
determine connectivity information of the base station from the received display identification data; and
connect the computer system to the base station via a second connection through the network interface using the determined connectivity information.

11. The computer system of claim 10, wherein the first connection is a wired video connection, and wherein the second connection is a network connection.

12. The computer system of claim 11, wherein the wired video connection conforms to a High Definition Multimedia interface (HDMI) specification or a DisplayPort specification.

13. The computer system of claim 11, wherein the network connections comprises at least one of an Ethernet connection, a Wide Area Network (WAN) connection, an Internet connection, a cellular connection, a Local Area Network (LAN) connection, an intranet connection, or a Wireless Local Area Network (WLAN) connection.

14. The computer system of claim 11, wherein the processing unit is further configured to communicate content to the base station, wherein the communication is performed using the first connection or the second connection.

15. The computer system of claim 11, wherein the processing unit is further configured to identify the base station based on the display identification data.

16. The computer system of claim 11, wherein the processing unit is further configured to provide a control signal to the base station via the second connection.

17. The computer system of claim 16, wherein the control signal is provided to the base station in response to a user input received by the processing unit.

18. The computer system of claim 16, wherein the provided control signal is one of: start a conference, end a conference, join a conference, control loudspeaker volume, or change a display option.

19. A base station, comprising:
a video output configured to:
provide over a first connection, display identification data associated with the base station when a computer system is connected to the video output via the first connection;
a network interface; and
a processing unit coupled to the video output, the processing unit being configured to:
connect the base station to the computer system through the network interface via a second connection,
wherein the display identification data includes connectivity information for the second connection information that identifies the base station.

20. The base station of claim 19, wherein the first connection is a wired video connection, and wherein the second connection is a network connection.

21. The base station of claim 20, wherein the wired video connection conforms to a High Definition Multimedia interface (HDMI) specification or a DisplayPort specification.

22. The base station of claim 20, wherein the network connection comprises at least one of an Ethernet connection, a Wide Area Network (WAN) connection, an Internet connection, a cellular connection, a Local Area Network (LAN) connection, an intranet connection, or a Wireless Local Area Network (WLAN) connection.

23. The base station of claim 20, wherein the processor is further configured to receive content from the computer system, wherein the communication is performed using the second connection.

24. The base station of claim 20, wherein the display identification data includes information that identifies the base station.

25. The base station of claim 20, wherein the processor is further configured to receive a control signal from the computer system via the second connection.

26. The base station of claim 25, wherein the control signal is provided to the processing unit in response to a user input received by the computer system.

27. The base station of claim 25, wherein the provided control signal is tone of: start a conference, end a conference, join a conference, control loudspeaker volume, or change a display option.

28. A method, comprising:
providing over a first connection and by a base station, display identification data associated with the base station, and wherein a computer system is connected to the base station via the first connection; and
connecting the base station to the computer system via a second connection, wherein the display identification data includes connectivity information for the second connection.

29. The method of claim 28, wherein the first connection includes a wired video connection, and wherein the second connection includes one or more network connections.

30. The method of claim 29, wherein the wired video connection conforms to a High Definition Multimedia interface (HDMI) specification or a DisplayPort specification.

31. The method of claim 29, wherein the one or more network connections comprises at least one of an Ethernet connection, a Wide Area Network (WAN) connection, an Internet connection, a cellular connection, a Local Area Network (LAN) connection, an intranet connection, or a Wireless Local Area Network (WLAN) connection.

32. The method of claim 29, further comprising communicating data that includes at least image data with the computer system, wherein the communication is performed using the first connection or the second connection.

33. The method of claim 29, wherein the display identification data includes information that identifies the base station.

34. The method of claim 29, further comprising receiving a control signal from the computer system via the first connection or the second connection.

35. The method of claim 34, wherein the control signal is provided to the base station in response to user input being received by the computer system.

36. The method of claim 34, wherein the provided control signal is to: start a conference, end a conference, join a conference, control loudspeaker volume, or change a display option.
